(19) United States
(12) Patent Application Publication
(10) Pub. No.: US 2010/0320065 A1
(43) Pub. Date: Dec. 23, 2010

(54) CONVERSIONAL KEYPAD PACKAGE USING LIGHT GUIDING SHEETS

(76) Inventor: Woo Yeon Cho, Gyeonggi-do (KR)

Correspondence Address: JORDAN AND HAMBURG LLP, 122 EAST 42ND STREET, SUITE 4000, NEW YORK, NY, 10168, US

(21) Appl. No.: 12/665,754

(22) PCT Filed: Apr. 30, 2008
(86) PCT No.: PCT/KR2008/002437

§ 371 Date: Dec. 30, 2009

(30) Foreign Application Priority Data
Jun. 20, 2007 (KR) 20-2007-0010145

(51) Int. Cl. H01H 9/00

(52) U.S. Cl. 200/312; 200/313

(57) ABSTRACT

The present invention relates to a conversional keypad package using light guiding sheets. More particularly, the present invention relates to a keypad package which can convert displayed patterns between number patterns and character patterns, by equipping the keypad package with both a light guiding sheet where the number patterns are formed and a light guiding sheet where the character patterns are formed and by illuminating each light guiding sheet separately. According to the first preferred embodiment of the present invention, there is provided with a conversional keypad package using light guiding sheets comprising: a first light guiding sheet formed by screen printing paste as number patterns on one surface of transparent sheet; a second light guiding sheet placed on the first light guiding sheet and formed by screen printing paste as character patterns on one surface of transparent sheet; and a semi-transparent film placed between the first light guiding sheet and the second light guiding sheet and configured to selectively block the number patterns of the first light guiding sheet, wherein lights are provided to the first light guiding sheet and the second light guiding sheet independently.

### TECHNICAL FIELD

The present invention relates to a conversional keypad package using light guiding sheets. More particularly, the present invention relates to a conversional keypad package which can convert displayed patterns between number patterns and character patterns, by equipping the keypad package with both a light guiding sheet where the number patterns are formed and a light guiding sheet where the character patterns are formed and by illuminating each light guiding sheet separately.

### BACKGROUND ART

As the desires of mobile phone consumers have increased and technologies have been developed to meet such demands, the functions of mobile phones have broadened from simple voice communication to video communication, Internet access, portable TV, MP3 player, camera, navigation, portable memory and infrared communication, etc. As the modern mobile phone has been able to perform such multiple functions, consumer's preferences or a dependence on their mobile phone has become more considerable. Now, it is a major technical trend that relevant manufactures try to include as many functions as possible into their mobile phones.

According to such trend, the smart phone, which is a representative mobile communication terminal, is provided with functions similar to a personal computer, still focusing on unique characteristics, shape and size of mobile phones, so that it has become necessary to display a lot of keypad numbers or characters.

However, the size of characters and numbers on the keypad must be small because it is necessary to display a lot of numbers and characters on the conventional keypad of a limited size used for mobile phones. As a result, a lot of attention is required when pressing the buttons on the keypad of the mobile phone and a drawback is that it easily makes the eyes of users feel fatigue. Such negative aspects are becoming serious due to the minimization trend of mobile phones.

### DISCLOSURE

### Technical Problem

The present invention aims to solve the above-mentioned problems and to provide a conversional keypad package separately comprising a light guiding sheet with character patterns formed thereon and a light guiding sheet with number patterns formed thereon in connection with the structure of the keypad of mobile phones, and providing the respective light guiding sheets with separate light radiation, thereby enabling conversions between number patterns and character patterns. The conversional keypad package can reduce the strain on the eyes of mobile phone user by enabling only specific patterns to be observed when using mobile phones.

### Technical Solution

In order to solve the above-mentioned problems, there is provided with a conversional keypad package using light guiding sheets according to a first preferred embodiment of the present invention, comprising: a first light guiding sheet formed by screen printing paste as number patterns on one surface of transparent sheet; a second light guiding sheet placed on the first light guiding sheet and formed by screen printing paste as character patterns on one surface of transparent sheet; and a semi-transparent film placed between the first light guiding sheet and the second light guiding sheet and configured to selectively block the number patterns of the first light guiding sheet, wherein lights are provided to the first light guiding sheet and the second light guiding sheet independently.

Alternatively, there is provided with a conversional keypad package using light guiding sheets according to a second preferred embodiment of the present invention comprising: a first light guiding sheet formed by screen printing paste as number patterns on one surface of transparent sheet; a second light guiding sheet placed below the first light guiding sheet and formed by screen printing paste as character patterns on one surface of transparent sheet; and a semi-transparent film placed between the first light guiding sheet and the second light guiding sheet and configured to selectively block the character patterns of the second light guiding sheet, wherein lights are provided to the first light guiding sheet and the second light guiding sheet independently.

For the conversional keypad package using light guiding sheets according to those preferred embodiments of the present invention, the first light guiding sheet is connected to FPCB including an LED providing lights to the first light guiding sheet and the second light guiding sheet is connected to another FPCB including an LED providing lights to the second light guiding sheet.

Preferably, at least one of the number patterns and the character patterns can be configured as a color pattern.

Preferably, the first light guiding sheet, semi-transparent film and the second light guiding sheet can be combined using an adhesive or double-sided tape.

In the first preferred embodiment, the character patterns formed on the second light guiding sheet can be implemented by achromatic colors.

In the second preferred embodiment, the number patterns formed on the first light guiding sheet can be implemented by achromatic colors.

### ADVANTAGEOUS EFFECTS

The conversional keypad package using the light guiding sheets according to the present invention can ease the stress on the mobile phone user's eyes through the selective display of the number patterns or character patterns, by forming the number patterns and character patterns on separate light guiding sheets and separately providing the respective light guiding sheets with lights.

Further, the number patterns and the character patterns are formed on separate light guiding sheet independently rather than on the same light guiding sheet so that it is possible to display the number patterns and the character patterns in the same region, thereby enabling the user to identify numbers and characters on the keypad more easily, comparing with the conventional keypad package that had no choice but to reduce sizes of the number patterns and the character patterns so as to write number and character together in one space.

Further, it is possible to reduce the volume of the light source compared with the current conventional light source by mounting an LED for the light source on the side surface of the light guiding sheet, thereby contributing to making appliances such as mobile phones slimmer.

### DESCRIPTION OF DRAWINGS

FIG. 1 illustrates cross-sections of a conversional keypad package using light guiding sheets according to the preferred embodiment of the present invention.

FIG. 2 illustrates the first light guiding sheet according to the preferred embodiment of the present invention.

FIG. 3 illustrates the second light guiding sheet according to the preferred embodiment of the present invention.

FIG. 4 illustrates a combination of the light guiding sheets from FIGS. 2 and 3.

### BEST MODE

Hereinafter, the preferred embodiments of the present invention will be explained with reference to the attached drawings.

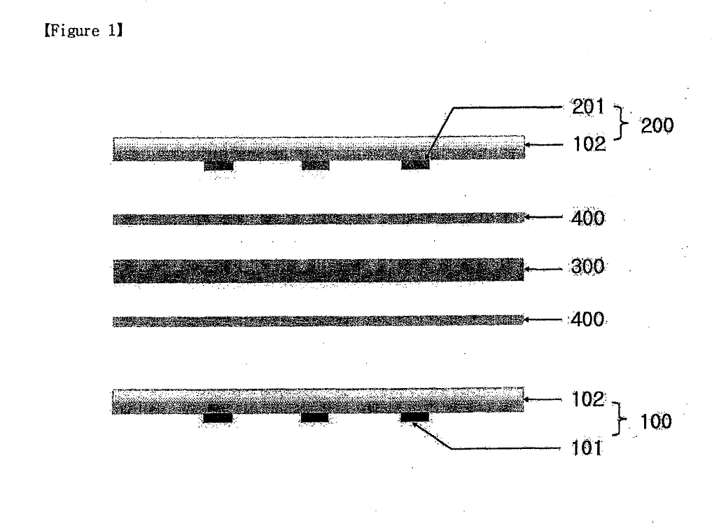

FIG. 1 illustrates cross-sections of the conversional keypad package using light guiding sheets according to the preferred embodiment of the present invention.

The conversional keypad package using light guiding sheets according to the preferred embodiment of the present invention comprises: a first light guiding sheet 100, a semi-transparent film 300 and a second light guiding sheet 200. The respective elements are combined using an adhesive (or, double-sided tape)400. In other words, the adhesive (or, double-sided tape)400 is used to combine the first light guiding sheet 100 and the semi-transparent film 300 and to combine the semi-transparent film 300 and the second light guiding sheet 200.

The first light guiding sheet 100 is a combination of number patterns 101 and a high transparency sheet made by screen printing paste with diffusion type reflection features on one surface of the high transparency sheet (Hereinafter, “transparent sheet”)102 such as PC, PE, PET, PU, PMMA, or glass etc.

The second light guiding sheet 200 is a combination of character patterns 201 and a high transparency sheet made by screen printing paste with diffusion type reflection features on one surface of another transparent sheet 102 such as PC, PE, PET, PU, PMMA, or glass etc.

The semi-transparent film 300 is placed between the first light guiding sheet 100 and the second light guiding sheet 200. Specifically, the semi-transparent film 300 is placed between the transparent sheet-sided surface of the first light guiding sheet 100 and the character patterns 201—sided surface of the second light guiding sheet 200.

In addition to the structure comprising the first light guiding sheet 100, the semi-transparent film 300 and the second light guiding sheet 200, a deposited sheet keypad(not shown) can be adhered to the transparent sheet-sided surface of the second light guiding sheet 200 using an adhesive(or, double-sided tape)400.

Colors of the respective elements in FIG. 1 were selected for convenient explanation so the colors of the respective elements according to the present invention should not be limited to the colors used in FIG. 1.

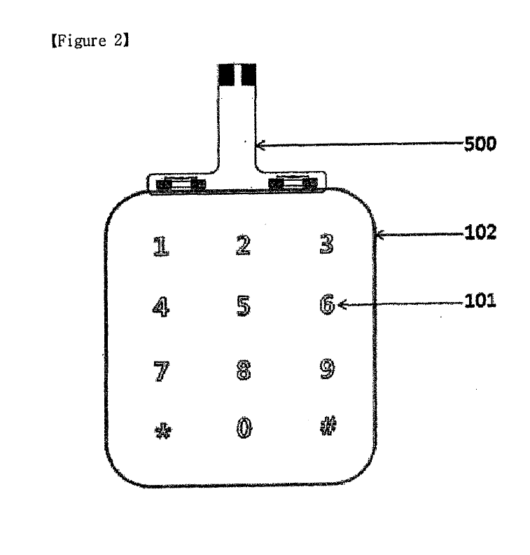

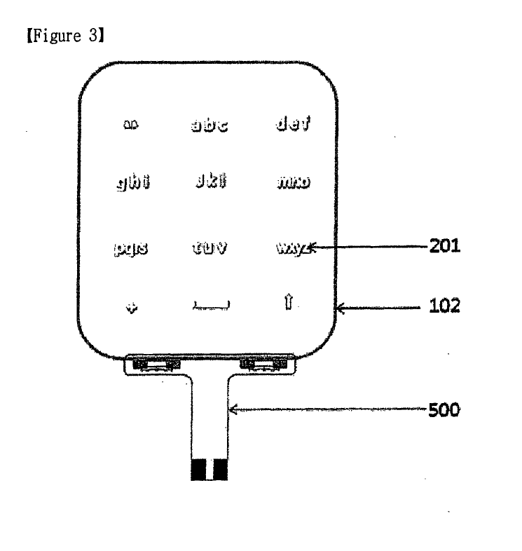

As shown in FIG. 2 and FIG. 3, a flexible printed circuit board(FPCB)500 including an LED light source for the first light guiding sheet 100 is connected to a side surface of the first light guiding sheet 100. Also, another FPCB including an LED light source for the second light guiding sheet 200 is connected to a side surface of the second light guiding sheet 200. For example, the LED for supplying the first light guiding sheet 100 with lights is provided to the side surface of the first light guiding sheet 100, and another LED for supplying the second light guiding sheet 200 with lights is provided to the side surface of the second light guiding sheet 200. The respective LEDs are turned on or turned off by the respective FPCBs and provides light to the side surfaces of the respective light guiding sheets. In this regard, the first light guiding sheet 100 and the second light guiding sheet 200 are separately provided with LED and FPCB so that the radiation of the lights toward each light guiding sheet is also independently performed. The construction of independently supplying the first light guiding sheet 100 and the second light guiding sheet 200 with lights is not described in detail. However, the construction will include a timing circuit configured to measure turn-on time and turn-off time of the LED that provides lights to the respective light guiding sheets, and a control circuit configured to control operations of the LED by controlling the timing circuit, etc. Here, means such as the control circuit, etc. can be implemented by ordinary means well known in the art and can be implemented by another construction electrically connected to or on the FPCB.

FIG. 2 illustrates the first light guiding sheet according to the preferred embodiment of the present invention.

The number patterns 101 are formed by screen printing paste with diffusion type reflection features on one surface of the transparent sheet such as PC, PE, PET, PU, PMMA, or glass etc. The paste used for forming the number patterns 101 can be implemented in colors. Any colors with high chroma will be desirable. The implementation of colors can be performed by adding color additives to the paste used for forming number patterns 101 prior to the screen printing. On the other hand, it is illustrated that FPCB 500 including LED is connected to a side surface close to numbers 1, 2 and 3 among side surfaces of the first light guiding sheet. However, locations of the FPCB and the LED are not limited to the illustrations of FIG. 2 and the FPCB including the LED can be connected to any of the side surfaces of the first light guiding sheet.

FIG. 3 illustrates a second light guiding sheet according to the preferred embodiment of the present invention.

The character patterns 201 are formed by screen printing paste with diffusion type reflection features on one surface of the transparent sheet such as PC, PE, PET, PU, PMMA, or glass etc. The paste used for forming the character patterns 201 can be implemented in colors. It is desirable to implement the color using an achromatic color. Also, the implementation of colors can be performed by adding color additives to the paste used for forming character patterns 201 prior to the screen printing. On the other hand, it is illustrated that FPCB 500 including the LED is connected to a side surface underneath among the side surfaces of the second light guiding sheet in FIG. 3. However, locations of the FPCB and the LED are not limited to the illustrations of FIG. 3 and the FPCB including the LED can be connected to any of the side surfaces of the second light guiding sheet.

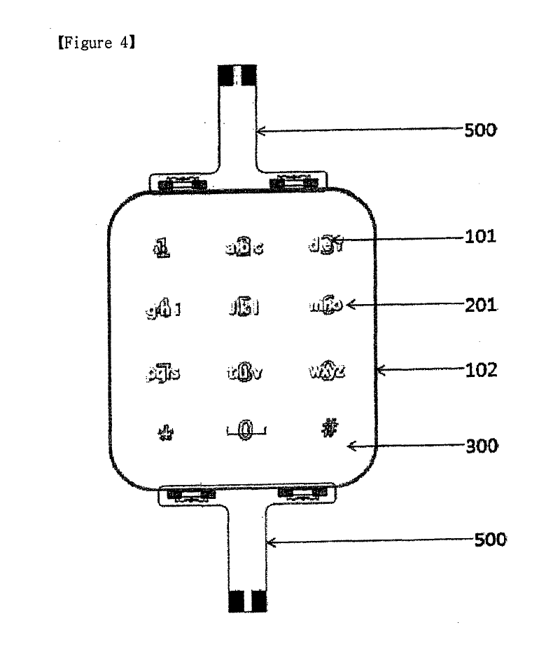

FIG. 4 illustrates a combination of the light guiding sheets in FIGS. 2 and 3.

FIG. 4 illustrates that the second light guiding sheet 200 with character patterns is placed on the first light guiding sheet 100 with number patterns. Further, FIG. 4 illustrates that a semi-transparent film 300 is located between the first light guiding sheet 100 and the second light guiding sheet 200. Here, although number patterns and character patterns are formed in the same region, there are no problems in displaying and identifying all the numbers and characters by independently supplying the respective light guiding sheets with lights, by using an achromatic color for paste used for forming character patterns 201, and by using high chroma colors for paste used for forming number patterns 101.

In this specification, it has been described that all the number patterns and the character patterns have colors, however, the present invention does not intend to exclude the constructions that some or all elements do not have colors. Further, it is described that the number patterns and the character patterns are formed in the same region and they seem to overlap. However, the scope of the claims according to the present invention is not limited to the above descriptions. On the other hand, the scope of the claims according to the present invention includes the construction that separately forms the number patterns and the character patterns on the respective light guiding sheets with separate radiation of the lights received and places the number patterns and the character patterns not to be overlapped.

Further, in the specification, it is described that the second light guiding sheet 200 with character patterns is placed on the first light guiding sheet 100 with number patterns. However, the present invention does not intend to exclude the construction that varies the location of the first light guiding sheet and the second light guiding sheet in order to place the second light guiding sheet 200 with character patterns below the first light guiding sheet 100 with number patterns. In this regard, in a case where the second light guiding sheet is placed below the first light guiding sheet, it can achieve the same effects as the case where the second light guiding sheet is placed on the first light guiding sheet, for example, by using an achromatic color for the paste used for forming number patterns, and by using high chroma colors for the paste used for forming character patterns.

Further, although it is described in the drawings attached to this specification that the number patterns and the character patterns are formed on the lower surface of each transparent sheet, the present invention should not be considered to exclude other constructions forming the respective patterns on the upper surface of each transparent sheet.

### INDUSTRIAL APPLICABILITY

Although this specification describes only some parts of the keypad package, those of ordinary skill in the art will appreciate that the description of the present invention is enough to work the invention because the constructions not described in the specification can be implemented through ordinary means.

A conversional keypad package according to the present invention is appropriate for mass production because the respective patterns are formed by screen-printing and thus the manufacturing process thereof is not complicated. In addition, it is possible to implement patterns with desirable colors by adding color additives to the paste for screen-printing.

1. A conversional keypad package using light guiding sheets comprising:
a first light guiding sheet formed by screen printing paste as number patterns on one surface of transparent sheet;
a second light guiding sheet placed on the first light guiding sheet and formed by screen printing paste as character patterns on one surface of transparent sheet; and
a semi-transparent film placed between the first light guiding sheet and the second light guiding sheet and configured to selectively block the number patterns of the first light guiding sheet,
wherein lights are provided to the first light guiding sheet and the second light guiding sheet independently.

2. A conversional keypad package using light guiding sheets comprising:
a first light guiding sheet formed by screen printing paste as number patterns on one surface of transparent sheet;
a second light guiding sheet placed below the first light guiding sheet and formed by screen printing paste as character patterns on one surface of transparent sheet; and
a semi-transparent film placed between the first light guiding sheet and the second light guiding sheet and configured to selectively block the character patterns of the second light guiding sheet,
wherein lights are provided to the first light guiding sheet and the second light guiding sheet independently.

3. The conversional keypad package using light guiding sheets according to claim 1 or claim 2,
wherein the first light guiding sheet is connected to FPCB including an LED providing lights to the first light guiding sheet and the second light guiding sheet is connected to another FPCB including an LED providing lights to the second light guiding sheet.

4. The conversional keypad package using light guiding sheets according to claim 1 or claim 2,
wherein at least one of the character patterns and the number patterns are implemented in colors.

5. The conversional keypad package using light guiding sheets according to claim 1 or claim 2,
wherein the first light guiding sheet, the semi-transparent film and the second light guiding sheet are combined using an adhesive or double-sided tape.

6. The conversional keypad package using light guiding sheets according to claim 1,
wherein the number patterns formed on the second light guiding sheet are implemented by achromatic colors.

7. The conversional keypad package using light guiding sheets according to claim 2,
wherein the character patterns formed on the first light guiding sheet are implemented by achromatic colors.
